(19) United States
(12) Patent Application Publication
(10) Pub. No.: US 2026/0071898 A1
(43) Pub. Date: Mar. 12, 2026

(54) Conduit Body Cover with Circuit Board and Antenna

(71) Applicant: ABB Schweiz AG, Baden (CH)

(72) Inventors: Omar A. Lopez, Nesbit, MS (US); Anthony Cooper, Memphis, TN (US)

(73) Assignee: ABB Schweiz AG, Baden (CH)

(21) Appl. No.: 18/826,928

(22) Filed: Sep. 6, 2024

(51) Int. Cl. G01D 11/24; G01D 11/26; G08C 17/02; H01Q 1/22; H01Q 1/42

(52) U.S. Cl. CPC G01D 11/245; G01D 11/26; H01Q 1/22; H01Q 1/42; G08C 17/02

(57) ABSTRACT

A conduit body cover for protecting cables in a conduit body includes a coating which encapsulates a top surface of the conduit body cover, a circuit board positioned in a cavity of the conduit body cover, and a wireless antenna. The wireless antenna is positioned between the coating and the top surface of the conduit body cover. The wireless antenna sends measurement data obtained by the circuit board to an external entity.

### FIELD

The present disclosure relates to a conduit body cover for protecting cables in a conduit body.

### BACKGROUND

A cable conduit as part of a conduit system may protect cables that are used for transmitting electrical power or data. A conduit system may provide functions such as protecting a cable from, for example, a harsh environment, bundling of multiple cables, electrical shielding, and grounding. A conduit system may be hermetically closed, partially open, or open on all ends. However, when there is a need for adding wireless communicating electronics in conduit systems the metal construction of some conduit systems inhibits wireless communication. This can cause problems as knowing the condition inside of a conduit system may be of use in determining contamination risk or early failure detection for component inside of the conduit system or the conduit system itself. Without easy access to the internal condition of conduit systems users are left to estimate a condition inside the conduit system, faced with a decision to open up a sealed system, or replacing the conduit system prematurely.

### SUMMARY

An embodiment of the present disclosure provides conduit body cover for protecting cables in a conduit body includes a coating which encapsulates a top surface of the conduit body cover, a circuit board positioned in a cavity of the conduit body cover, and a wireless antenna. The wireless antenna is positioned between the coating and the top surface of the conduit body cover. The wireless antenna sends measurement data obtained by the circuit board to an external entity.

In an embodiment of the conduit body cover, the circuit board includes a sensor for obtaining the measurement data about an internal space of a conduit connected to the conduit body.

In an embodiment of the conduit body cover, the conduit body cover further includes a connector that is connected to the circuit board.

In an embodiment of the conduit body cover, the conduit body cover further includes one or more wires for sending the measurement data from the circuit board to the wireless antenna, the connector being connected to the wireless antenna via the one or more wires, and the wireless antenna being powered by the circuit board.

In an embodiment of the conduit body cover, the conduit body cover further includes a wire pass-through hole in the conduit body cover, wherein the one or more wires travel through the wire pass-through hole to connect the wireless antenna to the circuit board via the connector, the measurement data transmitted from the circuit board to the wireless antenna via the connector and the one or more wires.

In an embodiment of the conduit body cover, the wire pass-through hole further includes a sealing ring for sealing the wire pass-through hole and protecting the one or more wires.

In an embodiment of the conduit body cover, the conduit body cover further includes one or more mounting holes for attaching the conduit body cover to the conduit body.

In an embodiment of the conduit body cover, the conduit body cover is composed of a metal alloy and the coating is composed of a plastic composition.

In an embodiment of the conduit body cover, the circuit board is powered via an associated battery or via an electrical connection via the cables inside of an associated conduit.

In an embodiment of the conduit body cover, the wireless antenna includes a near-field communication (NFC) transmitter, a WiFi transmitter, or Bluetooth transmitter.

Another embodiment of the present disclosure provides a conduit body cover for protecting cables in a conduit body, the conduit body cover including a circuit board positioned in a cavity of the conduit body cover, and a wireless antenna. The wireless antenna is positioned between the circuit board and an internal surface of the conduit body cover. The wireless antenna sends measurement data obtained by the circuit board to an external entity.

In an embodiment of the conduit body cover, the conduit body cover is composed of a plastic or rubber composition.

In an embodiment of the conduit body cover, the conduit body cover further includes a connector that is connected to the circuit board.

In an embodiment of the conduit body cover, the conduit body cover further includes one or more wires for sending the measurement data from the circuit board to the wireless antenna, the connector being connected to the wireless antenna via the one or more wires, and the wireless antenna being powered by the circuit board.

In an embodiment of the conduit body cover, the conduit body cover further includes one or more mounting holes for attaching the conduit body cover to the conduit body.

In an embodiment of the conduit body cover, the circuit board is powered via an associated battery or via an electrical connection via the cables inside of an associated conduit.

In an embodiment of the conduit body cover, the circuit board includes a sensor for sensing an environmental condition of the conduit body.

Another embodiment of the present disclosure is directed to a conduit body cover for protecting cables in a conduit body, the conduit body cover including an opening on a top surface of the conduit body cover, a circuit board positioned in a cavity of the conduit body cover and within the opening of the conduit body cover, a wireless antenna for sending measurement data obtained by the circuit board to an external entity, and a section of material separate from the conduit body cover that covers the opening on the top surface of the conduit body cover. The wireless antenna is positioned between the circuit board and the window.

In an embodiment of the conduit body cover, the conduit body cover is composed of a metal alloy.

In an embodiment of the conduit body cover, the section of material includes a window that is composed of a plastic composition, a glass composition, or a fiberglass composition.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a perspective view of an exemplary conduit body cover, according to one or more examples of the present disclosure;

FIG. 2 illustrates a top plan view of an exemplary conduit body cover, according to one or more examples of the present disclosure;

FIG. 3 illustrates a detailed side view of an exemplary conduit body cover, according to one or more examples of the present disclosure;

FIG. 4 illustrates a perspective view of an exemplary conduit body cover, according to one or more examples of the present disclosure;

FIG. 5 illustrates a perspective view of an exemplary conduit body cover, according to one or more examples of the present disclosure; and

FIG. 6 illustrates an exemplary sealing ring for protecting wires associated with a conduit body cover, according to one or more examples of the present disclosure.

### DETAILED DESCRIPTION

The present disclosure describes a conduit body cover that solves the above and other problems associated with conventional conduit body covers. Exemplary conduit body covers described herein may include components and an arrangement of components for protecting cables or other components within a conduit body while still enabling the transmission of measurement data or data obtained about the conduit body or associated conduit to an external entity. For example, a coating, such as a polyvinyl chloride (PVC) coating may encapsulate a top surface of a conduit body cover that is primarily composed of a metal alloy. A circuit board may include a sensor that is configured to obtain measurement data about an internal space of a conduit connected to a conduit body. The circuit board may be positioned in a cavity of the conduit body cover and a wireless antenna may be positioned between the coating and the top surface of the conduit body cover. Wires may connect the circuit board to the wireless antenna for transmitting the measurement data to an external entity such as a computer system or computer device. As the wireless antenna is positioned externally to the metal alloy conduit body cover signals provided by the wireless antenna will not be prohibited from transmitting to the external entity. Additionally, the coating will still serve the purpose of protecting the wireless antenna from harsh environments, chemicals, or water which may be introduced to a conduit system. The conduit body covers described herein may still protect conduit bodies while enabling data obtained about the space in the conduit body or the associated conduit to still be transmitted out to external entities.

A conduit or cable conduit as used herein may include a hollow device or tube that is used for guiding and/or protecting one or more cables or components inside. In embodiments, a sensor, which may be a part of the circuit board or otherwise in communication with the circuit board (via wired or wireless means), may be configured for obtaining data indicative of an environmental condition in an interior of the conduit or conduit body. The conduit itself may be made of plastic composition or metal alloy composition that is adapted for shielding electromagnetic fields or for thermal isolation. The conduit may be an extruded cylinder or may comprise multiple parts which are attached to each other and an interior space of the conduit may accommodate one or more cables.

In embodiments the sensor may be configured to monitor or obtain data/information about environmental conditions such as temperature, humidity, pressure, smoke, conductivity, vibrations, or other conditions within the conduit or conduit body.

Multiple sensors may be placed throughout a conduit system, a conduit, or a conduit body that each transmit their measurement data to the circuit board. The circuit board may communicate or otherwise utilize the wireless antenna to transmit the measurement data to an external entity such as an external computer system for further analysis. For example, the external computer system may compare the measurement data to one or more thresholds to determine whether a water leak is present within a conduit system, or whether an operating temperature for the conduit system is too high or too low.

The external entity may provide signals or instructions to an actuator or multiple actuators of the conduit system, conduit body, and/or conduit for changing an environmental condition in an interior space of the conduit system, conduit body, and/or conduit. For example, the actuator may include or be associated with a ventilator that may actuate to change an operating temperature of a corresponding conduit to normal operating temperature range in response to instructions from an external computer system. In embodiments, an external computer system may transmit signals or instructions to the circuit board, which may be in communication with one or more actuators, via the wireless antenna of the conduit body cover. The received signals may then be further transmitted by the circuit board to the actuators in order to change an environmental condition of an associated conduit system, conduit body, and/or conduit. The circuit board may be configured to instruct the actuators directly to actuate in response to receiving signals or instructions, via the wireless antenna, from an external computer system.

In particular, exemplary aspects of the conduit body cover according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

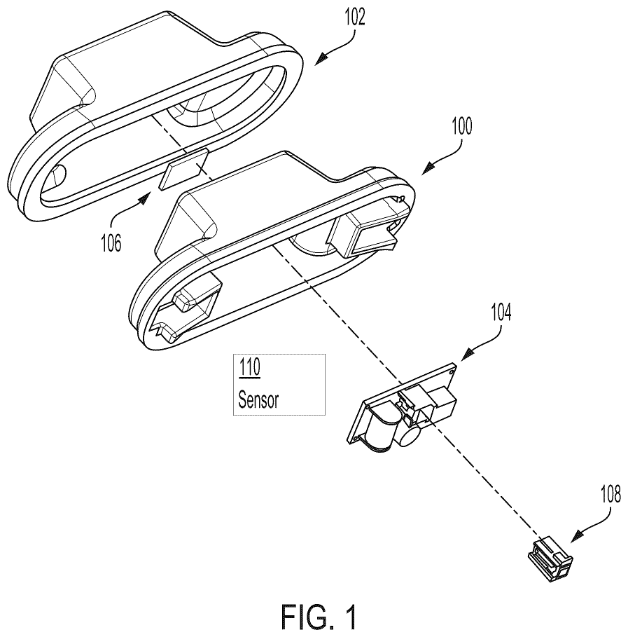

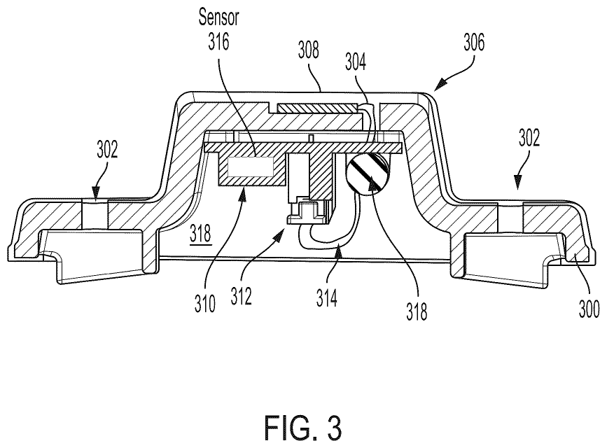

FIG. 1 illustrates a perspective view of an exemplary conduit body cover 100, according to one or more examples of the present disclosure. The conduit body cover 100 of FIG. 1 includes a coating 102, a circuit board 104, a wireless antenna 106, a connector 108, and a sensor 110. As depicted and described below with reference to FIG. 3, the circuit board 104 may be in communication with the wireless antenna 106 via one or more wires and the connector 108. The circuit board 104 and the wireless antenna 106 may be directly connected via the one or more wires. In embodiments, the connector 108 may be a wiring harness or other suitable mechanism for bundling or assembling the one or more wires of the circuit board. The coating 102 as described above may be composed of PVC, a plastic composition, a rubber composition, or other material which does not substantially interfere with the transmission of wireless data signals transmitted from the wireless antenna 106. In embodiments, the coating 102 may be co-molded to the conduit body cover 100, the conduit body cover 100 may be dipped into a material that forms the coating 102, or the coating 102 may be a separate cap of that fits mechanically on to the conduit body cover 100 so as to substantially cover the top surface area of the conduit body cover 100 and wireless antenna 106.

The circuit board 104 in some embodiments may be battery powered, receive power from local energy storage such as a capacitor, receive power from cables, such as a power line, within the conduit and/or conduit body, or may receive energy from a harvesting device such as a solar panel. The sensor 110 may be configured to monitor or obtain data/information about environmental conditions within an associated conduit or conduit body of the conduit body cover 100. The data/information (measurement data) may be transmitted to an external computer system via the circuit board 104 and wireless antenna 106. Although FIG. 1 depicts a singular sensor 110 embodiments disclosed herein are not limited to a single sensor 110 and may include multiple sensors placed throughout a conduit body or conduit(s) associated with the conduit body cover 100. In some embodiments the sensor 110 may be integrated into the circuit board 104.

The sensor 110 may communicate with the circuit board 104 directly via one or more wires or via other wireless means such as Bluetooth, Near Field Communication (NFC) transmitters/receivers, or via radio-frequency identification (RFID) tags. The conduit body cover 100 may be composed of a metal alloy, stamped sheet metal, or cast metal composition which prohibits the transmission of signals by antennas or wireless antennas from within a cavity of the conduit body cover 100, or from inside the conduit body cover 100 to outside of the conduit body cover 100 absent the features described herein. The wireless antenna 106 may be configured to wirelessly transmit measurement data obtained by the circuit board 104 to an external entity such as external computer system. The wireless antenna 106 may utilize wireless communication channels such as WiFi, Bluetooth, NFC, RFID channels or protocols, as well as other wireless protocols such as BLE, LoRa, GSM, IEEE 802.15.4g. The wireless antenna 106 may include WiFi, Bluetooth, NFC, or RFID transmitters and receivers or tags for transmitting measurement data to the external computer system as well as receiving signals or instructions from the external computer system. The placement of the wireless antenna 106 on the top surface of the conduit body cover 100 but underneath the protective coating 102 enables the reliable and accurate transmission of measurement data obtained by the sensor 110 and circuit board 104 to an external entity such as an external computer system. The metal alloy composition of the conduit body cover 100 does not interfere with the wireless data transmission of the wireless antenna 106 because of the placement of the wireless antenna 106 while the coating 102 protects the wireless antenna 106 from a harsh environment. The coating 102 also does not prohibit the wireless data transmission from the wireless antenna 106 due to its plastic, PVC, or rubber composition.

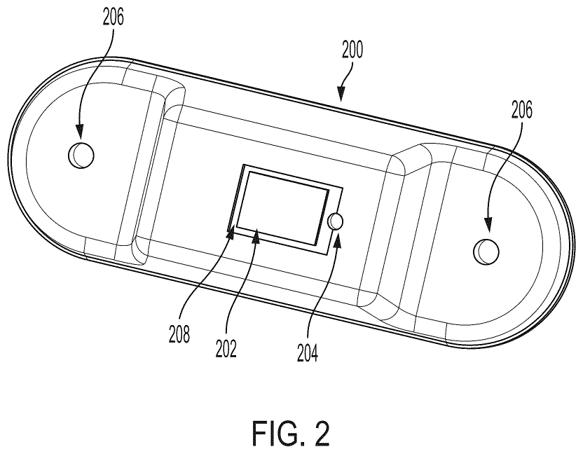

FIG. 2 illustrates a top plan view of an exemplary conduit body cover 200, according to one or more examples of the present disclosure. The conduit body cover 200 includes wireless antenna 202, a wire pass-through hole 204, and mounting holes 206. In embodiments, the conduit body cover 200 includes a depression or hollow space 208 on the top surface of the conduit body cover 200 for placing the wireless antenna 202. The depression or hollow space 208 on the top surface of the conduit body cover 200 may be of dimensions that correspond to the dimensions for the wireless antenna 202 or of other dimensions allowing for the placement of multiple wireless antennas on the top surface of the conduit body cover 200. Although the exemplary conduit body cover 200 of FIG. 2 includes a depression or hollow space 206, not all embodiments of the conduit body covers discussed herein are required to include the depression or hollow space 208.

Instead, the wireless antenna 202 may be placed on the top surface of the conduit body cover and held in place by the coating such as coating 102 of FIG. 1. In embodiments, the wireless antenna 202 may be held or otherwise attached to the conduit body cover 200 via a thermal paste, glue, or other suitable means for attaching an antenna to a surface which do not impede the transmission and receiving of wireless data/information. The wire pass-through hole 204 may enable the one or more wires which directly connect the circuit board to the wireless antenna 202 to travel unimpeded while maintaining the protection of the conduit body, cables, and other components on the inside of the conduit body cover 200. The one or more wires and connection to the wireless antenna are depicted and described below with reference to FIG. 3. The mounting holes 206 may enable the attaching of the conduit body cover 200 to a conduit body of a conduit system using one or more fasteners of similar dimensions to the mounting holes 206. Although the conduit body cover 200 of FIG. 2 includes multiple mounting holes 206 more or less mounting holes may be used to attach the conduit body cover 200 to a conduit body. In some embodiments, the conduit body cover 200 does not include mounting holes 206. Instead, the conduit body cover 200 may utilize projections or attachment elements that protrude from the conduit body cover 200 to fit onto the conduit body or otherwise snap fit onto the conduit body.

FIG. 3 illustrates a detailed side view of an exemplary conduit body cover 300, according to one or more examples of the present disclosure. The conduit body cover 300 includes mounting holes 302, wire pass-through hole 304, coating 306, wireless antenna 308, circuit board 310, connector 312, one or more wires 314, sensor 316, and battery 318.

Although the conduit body cover 300 depicted in the figures for the present disclosure is of a certain shape the embodiments described herein are not limited to this particular shape. For example, the conduit body cover 300 may be of a shape and dimension that corresponds to a 7 and 8 conduit body. As depicted in FIG. 3, the circuit board 310, sensor 316 (which in the depicted in embodiment is integrated into the circuit board 310), and connector 312 are positioned in a cavity 318 or internal cavity of the conduit body cover 300. The wireless antenna 308 is positioned between a top surface of the conduit body cover 300 and the coating 306. The one or more wires 314 directly connect the circuit board 310 via connector 312 and wire pass-through hole 304. The coating 306 protects the wireless antenna 308 but does not prohibit the transmitting or receiving of data by the wireless antenna 308 as it is composed of PVC, plastic, or rubber instead of a metal alloy or metal composition of the conduit body cover 300. The battery 318 may provide power or energy to the circuit board 310, sensor 316, and/or wireless antenna 308 (via the one or more wires 314).

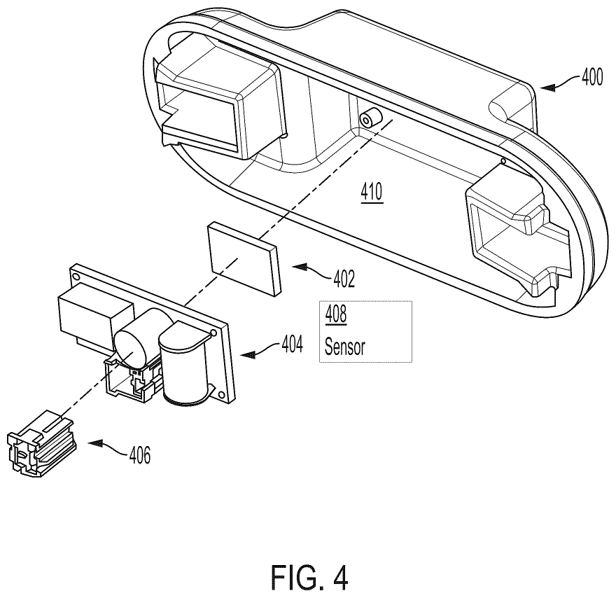

FIG. 4 illustrates a perspective view of an exemplary conduit body cover 400, according to one or more examples of the present disclosure. The conduit body cover 400 of FIG. 4 includes a wireless antenna 402, a circuit board 404, a connector 406, and a sensor 408. In an embodiment, the conduit body cover, such as conduit body cover 400, is composed of a plastic composition or rubber composition. As such, the conduit body cover 400 does not prohibit or otherwise impede the transmitting or receiving of data by the wireless transmitter 402 as it is not composed of a metal alloy. In the configuration depicted in FIG. 4 the circuit board 404, sensor 408, and connector 406 are positioned in a cavity 410 of the conduit body cover 400. The wireless antenna 402 is positioned between the circuit board 404 and an internal surface or bottom surface of the conduit body cover 400. In embodiments, one or more wires may directly connect the circuit board 404 and the wireless antenna via the connector 406. As the wireless antenna 402 is also located within the cavity 410 of the conduit body cover no wire pass-through hole is necessary. The wireless antenna 402 may be powered via the circuit board 404.

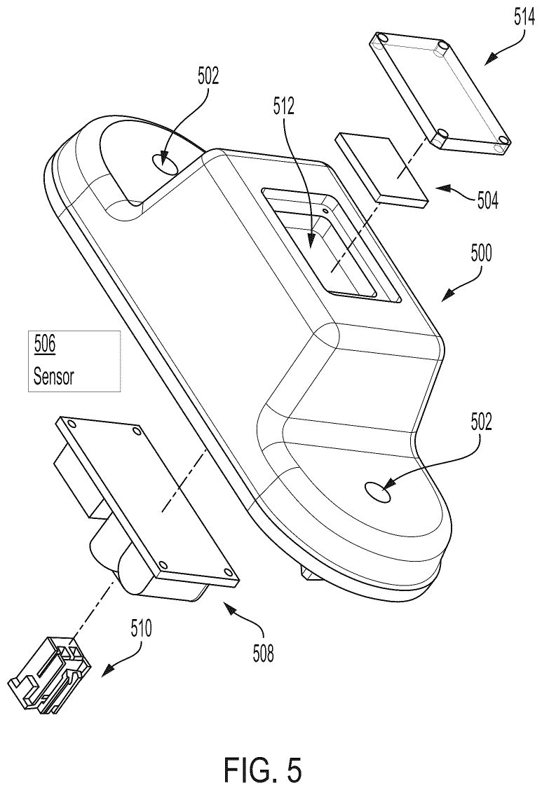

FIG. 5 illustrates a perspective view of an exemplary conduit body cover 500, according to one or more examples of the present disclosure. The conduit body cover 500 of FIG. 5 includes mounting holes 502, wireless antenna 504, sensor 506, circuit board 508, connector 510, opening 512, and a window 514. The conduit body cover 500 may be composed of a metal alloy composition. The sensor, circuit board 508, and connector 510 may be located or positioned within a cavity of the conduit body cover 500. The opening 512 may be located on a top surface of the conduit body cover 500 and the wireless antenna 504 may be positioned between the circuit board 508 and the window 514. The window 514 may cover the opening 512 and be composed of a plastic composition, glass composition, or a fiberglass composition.

In embodiments, the circuit board 508 may provide data or measurement data from the sensor 506 to the wireless antenna 504 via one or more wires and connector 510. In an embodiment, the wireless antenna 504 is directly attached or otherwise communicatively coupled to the circuit board 508 such that the circuit board 508 can directly provide the measurement data from the sensor 506 to the wireless antenna 504. The wireless antenna 504 may be positioned between the circuit board 508 which abuts against the internal surface or bottom surface of the conduit body cover 500 such that the wireless antenna 504 is outside the conduit body cover 500, and positioned in the opening 512. The wireless antenna 504 and the opening 512 are covered by the window 514 such that the wireless antenna 504 and components within the conduit body cover 500 are still protected (e.g. the window 514, opening 512, and conduit body cover 500 form an enclosed or sealed surface to protect the wireless antenna 504, circuit board 508, sensor 506, connector 510, and other components or cables of an associated conduit body). The mounting holes 502 may be used to attach or otherwise secure the conduit body cover 500 to a conduit body. The configuration depicted in FIG. 5 may still provide protection for the conduit body as the conduit body cover is composed of a metal alloy while still enabling unimpeded transmitting and receiving of data by the wireless antenna 504, as the wireless antenna 504 is located outside the conduit body cover 500 (or outside the cavity of the conduit body cover 500) but underneath a durable window 514 that forms a seal in the opening 512 of the conduit body cover 500. Although the window 514 may be provided as a transparent window embodiments disclosed herein are not limited to a transparent window. Instead, the window 514 may be comprised of a durable material that still enables electromagnetic radiation to pass through. The window 514 may be referred to as a separate section of material that serves the purpose of protecting the wireless antenna 504 and the internal components of the conduit body cover 500. As described above, the window 514 may be composed of a plastic composition, a glass composition, a fiberglass composition, or other material that is impermeable to liquids or solid objects but permeable to electromagnetic radiation.

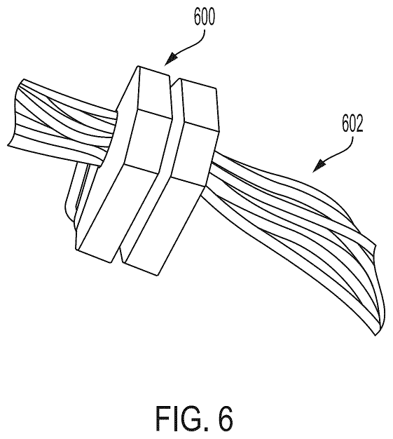

FIG. 6 illustrates an exemplary sealing ring 600 for protecting one or more wires 602 associated with a conduit body cover, according to one or more examples of the present disclosure. In embodiments, the sealing ring 600 may be composed of a durable plastic composition or rubber composition that is still flexible enough to fit into a wire pass-through hole of a conduit body cover while still providing protection to the one or more wires 602 connecting the circuit board and wireless antenna. The sealing ring 600 may be of a certain size and dimensions to fit within and around the wire pass-through hole of a conduit body cover while still providing a channel to allow passage of the one or more wires which directly connect the circuit board and the wireless antenna.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Indeed, the application may be exemplified in different forms and should not be construed as limited to the examples set forth herein; rather, these examples are provided so that the application will satisfy applicable legal requirements. Furthermore, when it is said herein that something is “based on” something else, it may be based on one or more other things as well. In other words, unless expressly indicated otherwise, as used herein “based on” means “based at least in part on” or “based at least partially on”.

What is claimed is:

1. A conduit body cover for protecting a cables in a conduit body, the conduit body cover comprising:
a coating which encapsulates a top surface of the conduit body cover;
a circuit board positioned in a cavity of the conduit body cover; and
a wireless antenna, the wireless antenna being positioned between the coating and the top surface of the conduit body cover, and wherein the wireless antenna sends measurement data obtained by the circuit board to an external entity.

2. The conduit body cover according to claim 1, wherein the circuit board includes a sensor for obtaining the measurement data about an internal space of a conduit connected to the conduit body.

3. The conduit body cover according to claim 1, further comprising a connector that is connected to the circuit board.

4. The conduit body cover according to claim 3, further comprising one or more wires for sending the measurement data from the circuit board to the wireless antenna, the connector being connected to the wireless antenna via the one or more wires, and the wireless antenna being powered by the circuit board.

5. The conduit body cover according to claim 4, further comprising a wire pass-through hole in the conduit body cover, wherein the one or more wires travel through the wire pass-through hole to connect the wireless antenna to the circuit board via the connector, the measurement data transmitted from the circuit board to the wireless antenna via the connector and the one or more wires.

6. The conduit body cover according to claim 5, wherein the wire pass-through hole further includes a sealing ring for sealing the wire pass-through hole and protecting the one or more wires.

7. The conduit body cover according to claim 1, further comprising one or more mounting holes for attaching the conduit body cover to the conduit body.

8. The conduit body cover according to claim 1, wherein the conduit body cover is composed of a metal alloy and the coating is composed of a plastic composition.

9. The conduit body cover according to claim 1, wherein the circuit board is powered via an associated battery or via an electrical connection via the cables inside of an associated conduit.

10. The conduit body cover according to claim 1, wherein the wireless antenna includes a near-field communication (NFC) transmitter, a WiFi transmitter, or Bluetooth transmitter.

11. A conduit body cover for protecting cables in a conduit body, the conduit body cover comprising:
a circuit board positioned in a cavity of the conduit body cover; and
a wireless antenna, the wireless antenna being positioned between the circuit board and an internal surface of the conduct body cover, and wherein the wireless antenna sends measurement data obtained by the circuit board to an external entity.

12. The conduit body cover according to claim 11, wherein the conduit body cover is composed of a plastic composition or rubber composition.

13. The conduit body cover according to claim 11, further comprising a connector that is connected to the circuit board.

14. The conduit body cover according to claim 13, further comprising one or more wires for sending the measurement data from the circuit board to the wireless antenna, the connector being connected to the wireless antenna via the one or more wires, and the wireless antenna being powered by the circuit board.

15. The conduit body cover according to claim 11, wherein the conduit body cover further comprises one or more mounting holes for attaching the conduit body cover to the conduit body.

16. The conduit body cover according to claim 11, wherein the circuit board is powered via an associated battery or via an electrical connection via the cables inside of an associated conduit.

17. The conduit body cover according to claim 11, wherein the circuit board includes a sensor for sensing an environmental condition of the conduit body.

18. A conduit body cover for protecting cables in a conduit body, the conduit body cover comprising:
an opening on a top surface of the conduit body cover;
a circuit board positioned in a cavity of the conduit body cover and within the opening of the conduit body cover;
a wireless antenna for sending measurement data obtained by the circuit board to an external entity; and
a section of material separate from the conduit body cover that covers the opening on the top surface of the conduit body cover, wherein the wireless antenna is positioned between the circuit board and the window.

19. The conduit body cover according to claim 18, wherein the conduit body cover is composed of a metal alloy.

20. The conduit body cover according to claim 18, wherein the section of material includes a window that is composed of a plastic composition, a glass composition, or a fiberglass composition.
